(19) United States
(12) Patent Application Publication
(10) Pub. No.: US 2014/0323638 A1
(43) Pub. Date: Oct. 30, 2014

(54) PROCESS FOR PREPARING POLYURETHANE ACRYLIC HYBRID DISPERSIONS

(71) Applicants: Jiguang Zhang, Shanghai (CN); Shouxue Guo, Shanghai (CN); Yujiang Wang, Shanghai (CN); Shaoguang Feng, Shanghai (CN); Siyuan Jiang, Shanghai (CN); Caifeng Wang, Shanghai (CN); Fujun Lu, Shanghai (CN)

(72) Inventors: Jiguang Zhang, Shanghai (CN); Shouxue Guo, Shanghai (CN); Yujiang Wang, Shanghai (CN); Shaoguang Feng, Shanghai (CN); Siyuan Jiang, Shanghai (CN); Caifeng Wang, Shanghai (CN); Fujun Lu, Shanghai (CN)

(21) Appl. No.: 14/360,672

(22) PCT Filed: Dec. 22, 2011
(86) PCT No.: PCT/CN2011/084427

§ 371 Date: May 27, 2014

(51) Int. Cl. C08L 33/12; C09D 133/12; C09D 175/04; C08L 75/04

(52) U.S. Cl. CPC C08L 33/12; C08L 75/04; C09D 133/12; C09D 175/04
USPC 524/507; 525/454

(57) ABSTRACT

The present invention provides a new process for making polyurethane/acrylic (PUA) hybrid dispersions, specifically, it relates to a chemical hybrid method for preparing stable, super durable and water whitening resistant PUA hybrid dispersions. The present invention further provides a PUA hybrid dispersion prepared according to the above process and a coating composition comprising the PUA hybrid dispersion.

### FIELD

The invention relates to a new process for making polyurethane/acrylic (PUA) hybrid dispersions, more specifically, it relates to a chemical hybrid method for preparing stable, durable and good water whitening resistant PUA hybrid dispersions and the PUA hybrid dispersions produced by this process.

### BACKGROUND

Over the decades, there has been a concerted effort to reduce atmospheric pollution caused by volatile solvents which are emitted during painting processes. Due to environmental concerns, volatile organic compounds (VOCs) have come under strict regulation by the government. Therefore, one of the major goals of the coating industry is to minimize the use of organic solvents by formulating waterborne coating compositions which provide a smooth, high gloss appearance, as well as good physical properties including resistance to acid rain. While the solvent-type coatings provide many benefits, such as that they are fast-drying, have a high hardness, a high abrasion-resistance, a high water-resistance, a high chemical-resistance and a low price, the waterborne coatings have environment-friendly benefits in that they are not flammable or explosive. The waterborne coatings use water as the system solvent and contain no poisonous chemicals. They require no or low amounts of volatile organic compounds.

The unique advantage of polyurethane dispersions (PUDs) in relation to surface coatings is their ability to form coherent films and to control the microphase morphology by controlling the relative amounts of soft and hard segments in polymer chain. These features allow PUDs to be employed in a wide variety of surface coating applications where mechanical properties are particularly crucial. High abrasion resistance, superior toughness, elastomeric properties, and high extensibility at low temperature are typical benefits. However, relatively high raw material cost in comparison with a typical acrylic emulsion has restricted their use in many industrial applications. In an attempt to overcome this, it is a common practice to combine polyurethane dispersions with other relatively inexpensive polymers to obtain a cost/performance balance. Accordingly, the properties of polyurethane (PU) and the polyacrylate (PA) complement each other. The composite materials of PU and PA are better in terms of adhesion, film-formability, non-stickiness, weather-resistance, elongation and strength of the film than that of either the PA or the PU taken alone. Accordingly, since the development of PU, the modification of the PU by the PA has been an active research topic in the art.

Two methods can be used to modify PU with PA: physical methods and chemical methods. The physical method is achieved by mechanical mixing. In the physical method, aqueous PA and PU dispersions are independently prepared first, and then both dispersions are mixed together under mechanical power. A high speed mechanical stirrer may be used for this purpose. It is a very convenient method that makes it easy to control the particle size. However, in many cases these blends compromise the superior performance properties because of the incompatibility of the two systems in which the different polymers are present as separate particles.

For these reasons, the chemical modification method currently plays a more important role. The chemical method is achieved by post-polymerization of acrylates. In the chemical method, the PU dispersion can be prepared first, and then acrylates and other vinyl monomers can be polymerized in the PU dispersion. In most cases, core-shell emulsion polymerization is adopted. PU particles are used as core particles and the acrylates are polymerized in the PU particles due to high hydrophobicity of the acrylates. These hybrid dispersions are expected to provide the advantages of acrylic, such as excellent weather resistance, affinity to pigments as well as low cost, and the advantages of polyurethane (PU), such as excellent mechanical performance, excellent adhesion, solvent and chemical resistance, and toughness.

European Patent No. 1391471A1 to Dr. Rolf Gertzmann made an attempt in this technical art and disclosed a novel method for preparing aqueous, emulsifier-free and solvent-free PUA hybrid dispersions, by preparing a hydrophilic PU through reacting isocyanate components with an equimolar amount of one or more diols or polyols, low molecular weight diols or polyols, and hydrophilic compounds having at least one NCO-reactive group, in the presence of ethylenically unsaturated monomers which are inert towards NCO groups. The resulting NCO-free PU is dispersed in emulsion-polymerizable monomers.

However, the UV resistance, water whitening resistance of the above NCO-free PU is still not satisfying enough, which limits the applications of it in architectural coatings, especially in interior and exterior wall coatings. Further, the molar ratio of the two reacting components, isocyanate and polyol is 1:1 or below, there is no NCO residue in the resulting PU prepolymer, one cannot control the molecular weight of the PU prepolymers by detecting the NCO level, it will be very difficult to disperse PU prepolymer in water if the molecular weight of PU prepolymer is too high, and the performance of the PUA hybrid dispersions is hard to control.

There remains a need for a PUA hybrid dispersion manufactured through a solvent-free and environmentally friendly process, it retains excellent transparency, weather durability, UV resistance and water whitening resistance when using in coating compositions.

### SUMMARY

The present invention provides a process for preparing polyurethane/acrylic hybrid dispersions comprising the following continuous steps: a) reacting natural oil polyol with 1,3-bis(isocyanatomethyl)cyclohexane, 1,4-bis(isocyanatomethyl)cyclohexane, hexamethylene diisocyanate, or the mixture thereof, to form a polyurethane prepolymer with the weight average molecular weight being from 2800 to 5600; b) adding as a diluent simultaneously with/after step a), but before step c), 10-50% methyl methacrylate by weight based on the total weight of polyurethane prepolymer; c) adding hydroxyl carboxylic acids as water-dispersibility enhancing agents to the polyurethane prepolymer; d) dispersing and extending polyurethane prepolymer in the presence of methyl methacrylate; and e) adding at least one ethylenically unsaturated nonionic monomer(s) and polymerizing it together with the diluent methyl methacrylate.

The present invention further provides a process for preparing polyurethane/acrylic hybrid dispersions comprising the following continuous steps: a) reacting natural oil polyol with isophorone diisocyanate, to form a polyurethane prepolymer with the weight-average molecular weight being between 1600-2200; b) adding as a diluent simultaneously with/after step a), but before step c), 10-50% methyl methacrylate; by weight based on the total weight of polyurethane prepolymer c) adding hydroxyl carboxylic acids as water-dispersibility enhancing agents to the polyurethane prepolymer; d) dispersing and extending polyurethane prepolymer in the presence of methyl methacrylate; and e) adding at least one ethylenically unsaturated nonionic monomer(s) and polymerizing it together with the diluent methyl methacrylate.

The present invention further provides polyurethane/acrylic hybrid dispersions made thereof.

The present invention further provides a coating composition comprising the PUA hybrid dispersion of the present invention.

### DETAILED DESCRIPTION

PU prepolymer is prepared by reacting natural oil polyol with at least one diisocyanate of the group consisting of 1,3- or 1,4-bis(isocyanatomethyl)cyclohexane (ADI), isophorone diisocyanate (IPDI), and hexamethylene diisocyanate (HDI) to form a polyurethane prepolymer. When using 1,3- or 1,4-bis(isocyanatomethyl)cyclohexane (ADI), hexamethylene diisocyanate (HDI), or the mixture thereof, the requested weight average molecular weight of the polyurethane prepolymer is from 2800 to 5600. When using isophorone diisocyanate, the requested weight average molecular weight of the polyurethane prepolymer is from 2800 to 5600. Simultaneously with the preparation of polyurethane prepolymer, or after the preparation of it, 10-50%, preferably, from 15-40% methyl methacrylate (MMA) by weight based on the total weight of PU prepolymer is added as a diluent. Hydroxyl carboxylic acids were added as water-dispersibility enhancing agents.

It is optionally that hydroxyl ethyl methacrylate (HEMA) is added after the PU prepolymer is prepared. Hydroxy ethyl methacrylate (HEMA) or hydroxyl propylacrylate (HPA) can be used as acrylic end-capping agent. It allows to get acrylic-polyurethane graft copolymers which are effective for improving the compatibility between acrylic and polyurethane components, further give finely dispersed domain structure.

The natural oil polyols (NOP) are polyols based on or derived from renewable feedstock such as natural and/or genetically modified plant vegetable seed oils and/or animal source fats. Such oils and/or fats are generally comprised of triglycerides, that is, fatty acids linked together with glycerol. Preferred are vegetable oils that have at least about 70 percent unsaturated fatty acids in the triglyceride. The natural product may contain at least about 85 percent by weight unsaturated fatty acids. Examples of preferred vegetable oils include, but are not limited to, for example, those from castor, soybean, olive, peanut, rapeseed, corn, sesame, cotton, canola, safflower, linseed, palm, grapeseed, black caraway, pumpkin kernel, borage seed, wood germ, apricot kernel, pistachio, almond, macadamia nut, avocado, sea buckthorn, hemp, hazelnut, evening primrose, wild rose, thistle, walnut, sunflower, jatropha seed oils, or a combination thereof. Additionally, oils obtained from organisms such as algae may also be used. Examples of animal products include lard, beef tallow, fish oils and mixtures thereof. A combination of vegetable and animal derived oils/fats may also be used.

Several chemistries can be used to prepare the natural oil polyols. Such modifications of a renewable feedstock include, but are not limited to, for example, epoxidation, hydroxylation, ozonolysis, esterification, hydroformylation, or alkoxylation of the feedstock. Such modifications are known in the art.

After the production of such polyols by modification of the natural oils, the modified products may be further alkoxylated. The use of ethylene oxide (EO) or mixtures of EO with other oxides, introduces hydrophilic moieties into the polyol. In one embodiment, the modified product undergoes alkoxylation with sufficient EO to produce a natural oil polyol with between 10 weight percent and 60 weight percent EO, for example, between 20 weight percent and about 40 weight percent EO.

In another embodiment, the natural oil polyols are obtained by a multi-step process wherein the animal or vegetable oils/fats are subjected to transesterification and the constituent fatty acids recovered. This step is followed by hydroformylating carbon-carbon double bonds in the constituent fatty acids to form hydroxymethyl groups, and then forming a polyester or polyether/polyester by reaction of the hydroxymethylated fatty acid with an appropriate initiator compound. Such a multi-step process is commonly known in the art, and is described, for example, in PCT publication Nos. WO 2004/096882 and 2004/096883. The multi-step process results in the production of a polyol with both hydrophobic and hydrophilic moieties, which results in enhanced miscibility with both water and conventional petroleum-derived polyols.

The initiator for use in the multi-step process for the production of the natural oil polyols may be any initiator used in the production of conventional petroleum derived polyols. The initiator may, for example, be selected from the group consisting of neopentylglycol; 1,2-propylene glycol; trimethylolpropane; pentaerythritol; sorbitol; sucrose; glycerol; diethanolamine; alkanediols such as 1,6-hexanediol, 1,4-butanediol; 1,4-cyclohexane diol; 2,5-hexanediol; ethylene glycol; diethylene glycol, triethylene glycol; bis-3-aminopropyl methylamine; ethylene diamine; diethylene triamine; 9(1)-hydroxymethyloctadecanol, 1,4-bishydroxymethylcyclohexane; 8,8-bis(hydroxymethyl)tricyclo[5,2,1,02′6]decene; Dimerol alcohol (36 carbon diol available from Henkel Corporation); hydrogenated bisphenol; 9,9(10,10)-bishydroxymethyloctadecanol; 1,2,6-hexanetriol and combination thereof. In the alternative, the initiator may be selected from the group consisting of glycerol; ethylene glycol; 1,2-propylene glycol; trimethylolpropane; ethylene diamine; pentaerythritol; diethylene triamine; sorbitol; sucrose; or any of the aforementioned where at least one of the alcohol or amine groups present therein has been reacted with ethylene oxide, propylene oxide or mixture thereof; and combination thereof. In another alternative, the initiator is glycerol, trimethylopropane, pentaerythritol, sucrose, sorbitol, and/or mixture thereof.

In one embodiment, the initiators are alkoxlyated with ethylene oxide or a mixture of ethylene oxide and at least one other alkylene oxide to give an alkoxylated initiator with a molecular weight between about 200 and about 6000, preferably between about 500 and about 3000.

The average hydroxyl functionality of the natural oil polyol is in the range of from 1 to 10; or preferably, in the range of from 1.5 to 6 or, for example, from 2 to 4. And the natural oil polyol may have a number average molecular weight in the range of from 100 to 3,000; for example, from 300 to 2,000; or preferably, from 350 to 1,500.

The hydroxyl number of the at least one natural oil polyol is below about 150 mg KOH/g, preferably between about 50 and about 120, more preferably between about 60 and about 120. In one embodiment, the hydroxyl number is below about 100.

The level of renewable feedstock in the natural oil polyol can vary between about 10 and about 100 percent, usually between about 10 and about 90 percent.

The natural oil polyols may constitute up to about 90 weight percent of a polyol blend. However, in one embodiment, the natural oil polyol may constitute at least 5 weight percent, at least 10 weight percent, at least 25 weight percent, at least 35 weight percent, at least 40 weight percent, at least 50 weight percent, or at least 55 weight percent of the total weight of the polyol blend. The natural oil polyols may constitute 40 percent or more, 50 weight percent or more, 60 weight percent or more, 75 weight percent or more, 85 weight percent or more, 90 weight percent or more, or 95 weight percent or more of the total weight of the combined polyols. Combination of two types or more of natural oil polyols may also be used. The viscosity measured at 25° C. of the natural oil polyols is generally less than about 6,000 mPa·s; for example, the viscosity measured at 25° C. of the natural oil polyols is less than about 5,000 mPa·s.

An NOP may be blended with any of the following: aliphatic and aromatic polyester polyols including caprolactone derived polyester polyols, any polyester/polyether hybrid polyols, PTMEG-derived polyether polyols; polyether polyols made fromon ethylene oxide, propylene oxide, butylene oxide and mixtures thereof; polycarbonate polyols; polyacetal polyols, polyacrylate polyols; polyesteramide polyols; polythioether polyols; polyolefin polyols such as saturated or unsaturated polybutadiene polyols. Non-limiting examples of the hydroxy-carboxylic acids useful in the present invention include dimethylolpropanic acid (DMPA), dimethylol butanoic acid (DMBA), citric acid, tartaric acid, glycolic acid, lactic acid, malic acid, dihydroxymaleic acid, dihydroxytartaric acid, and the like, and mixtures thereof. Dihydroxy-carboxylic acids are preferred, of which dimethylolproanoic acid (DMPA) is especially preferred.

Other suitable water-dispersibility enhancing compounds include, but are not limited to, thioglycolic acid, 2,6-dihydroxybenzoic acid, sulfoisophthalic acid (this component would preferably be incorporated as part of a polyester), polyethylene glycol, and the like, and mixtures thereof.

The PU prepolymer may be formed without using a catalyst if desired, but using a catalyst may be preferred in some embodiments of the present invention. Non-limiting examples of suitable catalysts include stranous octoate, dibutyl tin dilaurate, and tertiary amine compounds such as triethylamine and bis-(dimethylaminoethyl)ether, morpholine compounds, bismuth carboxylate, zinc bismuth carboxylate and diazabicyclo[2.2.2]octane. Organic tin catalysts are preferred.

Optionally, the hydroxyl components, including polyols, hydroxyl carboxylic acids and extending agents, are fed into a reactor in one batch in the preparation of the PU prepolymer. In most of the existing methods, the polyols and polyisocyanates react first, and then carboxylic acid and extending agents are added. But in most cases, these existing methods necessarily produce products having a very high viscosity and require the use of an organic solvent.

In the present invention, organic solvents are preferably not used, so the solvent-removing stage is not necessary.

PU prepolymer prepared according to the above is extended and dispersed in the presence of ethylenically unsaturated nonionic monomers.

The ethylenically unsaturated nonionic monomers include, for example, (meth)acrylic ester monomers, where (meth)acrylic ester designates methacrylic ester or acrylic ester, including methyl acrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate, hydroxyethyl methacrylate, hydroxypropyl methacrylate; (meth)acrylonitrile; (meth)acrylamide; amino-functional and ureido-functional monomers; monomers bearing acetoacetate-functional groups; styrene and substituted styrenes; butadiene; ethylene, propylene, α-olefins such as 1-decene; vinyl acetate, vinyl butyrate, vinyl versatate and other vinyl esters; and vinyl monomers such as vinyl chloride, vinylidene chloride.

Herein, “nonionic monomer” means that the copolymerized monomer residue does not bear an ionic charge between pH=1-14.

Ethylenically unsaturated nonionic monomers are polymerized by known techniques.

The PUA hybrid dispersion prepared according to the present invention is used as a binder in a coating composition.

The coating composition of the present invention contains at least one conventional coatings adjuvant, including but not limited to, coalescing agents, cosolvents, surfactants, buffers, neutralizers, thickeners, non-thickening rheology modifiers, dispersants, humectants, wetting agents, midewcides, biocides, plasticizers, antifoaming agents, defoaming agents, anti-skinning agents, colorants, flowing agents, crosslinkers, anti-oxidants.

The coating composition formulating involves the process of selecting and admixing appropriate coating ingredients in the correct proportions to provide paints with specific processing and handling properties, as well as a final dry paint film with the desired properties.

The coating composition may be applied by conventional application methods such as, for example, brushing, roller application, and spraying methods such as, for example, air-atomized spray, air-assisted spray, airless spray, high volume low pressure spray, and air-assisted airless spray. Suitable substrates include, but not limited to, for example, concrete, cement board, MDF and particle board, gypsum board, wood, stone, metal, plastics, wall paper and textile, etc. preferably, all the substrate are pre-primed by waterborne or solvent borne primers.

In the present specification, the technical features in each preferred technical solution and more preferred technical solution can be combined with each other to form new technical solutions unless indicated otherwise. For briefness, the applicant omits descriptions of these combinations. However, all the technical solutions obtained by combining these technical features should be deemed as being literally described in the present specification in an explicit manner.

### EXAMPLES

### I. Raw Materials

Materials used for preparing the PUA hybrid dispersion

| | Chemical | |
|---|---|---|
| Function | nature | Abbreviation |
| Polyol | Polypropylane glycol | PPG1k |
| | (Mw = 1000) | |
| | Polypropylane glycol | PPG2k |
| | (Mw = 2000) | |
| | Poly(butanediol adipate) | PBA2k |
| | (Mw = 2000) | |
| | Polycarprolactone | PCL2k |
| | (Mw = 2000) | |
| | Polyethylene glycol | PEG400 |
| | (Mw = 400) | |
| | Polytetrahydrofuran | PTMEG2k |
| | (Mw = 2000) | |
| | Natural oil polyol | NOP(G1)* |
| | Generation 1 | |
| | Natural oil polyol | NOP(G4)* |
| | Generation 4 | |
| Isocyanate | Isophorone diisocyanate | IPDI |
| | bis(isocyanatomethyl) | ADI |
| | cyclohexane | |
| | hexamethylene diisocyanate | HDI |
| | tolune diisocyanate | TDI |
| Catalyst for PU prepolymer | Dibutyltin dilaurate | DBTDL |
| Dispersing improving agent | Dimethyolpropionic acid | DMPA |
| Chain extender | 1,4-butanediol | BDO |
| Neutralizing agent | Triethylamine | TEA |
| Surfactant | Sodium dodecylsulphate | SDS |
| Acrylic monomer | Methyl methacrylate | MMA |
| | Butyl acrylate | BA |
| | Acrylic acid | AA |
| | Hydroxyl ethyl methacrylate | HEMA |
| | 2-ethylhexyl acrylate | 2-EHA |
| Other functional monomer | Diacetone acrylamide | DAAm |
| Initiator for | Tert-butyl hydrogen peroxide | TBHP |
| acrylic monomer | Tetraethylenepentamine | TEPA |
| polymerization | | |

*NOP (G1) is a natural oil polyol product of Dow Chemical Company derived from soy monomer and UNOXOL ™ Diol; and
NOP (G4) is a natural oil polyol product of Dow Chemical Company derived from soy monomer and Trimethylolpropane (TMP)

### II. Examples

### Example 1

### Preparation for PUA Hybrid Dispersion

(1) Putting 22.4 g NOP(G1), 0.04 g DBTDL, 22.0 g MMA and 2.4 g DMPA into a three-necked flask, stir and heat the flask;

(2) Adding 11.1 g ADI into the flask when the temperature of the reactant reaches to 50° C.;

(3) Keeping the reaction for 45 minutes at temperature 75° C.;

(4) Adding 3.3 g HEMA into the flask and continue to react for 30 minutes at 80° C.;

(5) Dissolving 3.8 g DAAm, 1.9 g ammonium hydroxide in 120 g De-ionized water and putting the solution into the flask, stir for 30 minutes at 80° C.;

(6) Cooling the reactant to 60° C., and add 8.0 g BA into the flask;

(7) Adding 0.15 g TBHP solution and 0.3 g TEPA into the flask separately, and stirring the reactant for 1 hr at 60° C. In some cases, ADH can be added into

(8) Filtering the dispersion with 100-mesh filter cloth and take the product as PUA hybrid dispersion of Exp. 1.

### Example 2

The procedure of Example 1 was repeated except that NOP (G4) was used as polyol in this sample.

### Example 3

The procedure of Example 1 was repeated except that reaction condition for stage (3) was 70° C. for 30 min.

### Example 4

The procedure of Example 1 was repeated except that reaction condition for stage (3) was 75° C. for 60 min.

### Example 5

The procedure of Example 1 was repeated except that reaction condition for stage (3) was 80° C. for 45 min.

### Example 6

The procedure of Example 1 was repeated except that reaction condition for stage (3) was 80° C. for 60 min.

### Example 7

The procedure of Example 1 was repeated except that IPDI was used as diisocyanate in this sample.

### Example 8

The procedure of Example 1 was repeated except that IPDI was used as diisocyanate in this sample and the reaction condition for stage (3) is 75° C. for 60 min

### Example 9

The procedure of Example 1 was repeated except that HDI was used as diisocyanate in this sample.

### Example 10

The procedure of Example 1 was repeated except that HDI was used as diisocyanate in this sample and the reaction condition for stage (3) is 75° C. for 60 min

### Comparative Example 1

(1) Putting 6 g PEG400 and 20 g PPG1K, 0.04 g DBTDL, 20 g MMA and 2 g DMPA into a three-necked flask, stir and heat the flask;

(2) Adding 10 g TDI into the flask when the temperature of the reactant reaches to 50° C.;

(3) Keeping the reaction for 45 minutes at temperature 75° C.;

(4) Adding 2.3 g HEMA into the flask and continuing to react for 30 minutes at 80° C.;

(5) Dissolving 4 g DAAm, 2 g ammonium hydroxide in water and put the solution into the flask, stir for 30 minutes at 80° C.;

(6) Cooling the reactant to 60° C., and adding 4 g BA into the flask;

(7) Adding 0.17 g TBHP solution and 0.35 g TEPA into the flask separately, and stirring the reactant for 1 hr at 60° C.;

(8) Filtrating the dispersion with 100-mesh filter cloth and taking the product as PUA hybrid dispersion of Comp. 1.

### Comparative Example 2

The procedure of Comparative example 1 was repeated except that ADI was used as diisocyanate in this example.

### Comparative Example 3

The procedure of Example 1 was repeated except that reaction condition for stage (3) was 80° C. for 90 min.

### Comparative Example 4

The procedure of Example 1 was repeated except that reaction condition for stage (3) was 80° C. for 30 min

### Comparative Example 5

The procedure of Example 1 was repeated except that IPDI was used as diisocyanate in this sample and reaction condition for stage (3) is 75° C. for 15 min

### Comparative Example 6

The procedure of Example 1 was repeated except that HDI was used as diisocyanate in this sample and reaction condition for stage (3) is 70° C. for 15 min

### Comparative Example 7

Cold blended product of Bayer PR-240 (a commercial PU dispersion of Bayer) with a commercial PA dispersion.

### III. Tests and Results

### i) Molecular Weight of Polyurethane Prepolymer

The weight-average molecular weight of PU polymer is measured by Agilend 1200 Gel Permeation Chromatography, the column is two mini mixed D column (4.6*250 mm) in tandren, and column temperature is 40° C., mobile phase is tetrahydrofuran, flow rate is 0.3 mL/min.

### ii) Stability of the PUA Dispersions

Stability of PUA dispersions was evaluated by a in-process stability and heat-aging stability through heat-ageing at 50° C. for 10 days. As shown in Table 1, for ADI/NOP system, if the PU prepolymer weight-average molecular weight is lower than 2800 or higher than 5600, the process stability of the PUA hybrid binder is rather poor (Comp. 3-4). For IPDI/NOP system, if the PU prepolymer weight-average molecular weight is lower than 1600 or higher than 2200, the process stability of the PUA hybrid binder is rather poor too. For HDI/NOP system, if the PU prepolymer weight-average molecular weight is lower than 3300 or higher than 4100, the process stability of the PUA hybrid binder is rather poor too. Viscosity of the cold blend sample (Comp. 7) showed dramatic increase after the test, almost gelled after heat-aging storage, while that of the inventive example did not show any change in appearance. All the inventive examples show very good in-process and storage stability.

TABLE 1

| | | | | Mw of PU | |
|---|---|---|---|---|---|
| Sample | Diisocya- | | Particle | Prepoly- | Stabil- |
| ID | nate | Polyol | size/nm | mer | ity |
| Example | ADI | NOP | 121 nm | 3500 | Stable |
| 1 | | (G1) | | | |
| Example | ADI | NOP | 90 nm | 5510 | Stable |
| 2 | | (G4) | | | |
| Example | ADI | NOP | 155 nm | 2980 | Stable |
| 3 | | (G1) | | | |
| Example | ADI | NOP | 163 nm | 3700 | Stable |
| 4 | | (G1) | | | |
| Example | ADI | NOP | 103 nm | 3750 | Stable |
| 5 | | (G1) | | | |
| Example | ADI | NOP | 123 nm | 4100 | Stable |
| 6 | | (G1) | | | |
| Example | IPDI | NOP | 228 nm | 1700 | Stable |
| 7 | | (G1) | | | |
| Example | IPDI | NOP | 387 nm | 2095 | Stable |
| 8 | | (G1) | | | |
| Example | HDI | NOP | 130 nm | 4000 | Stable |
| 9 | | (G1) | | | |
| Example | HDI | NOP | 152 nm | 3400 | Stable |
| 10 | | (G1) | | | |
| Comparative | TDI | PEG400/PP | <50 nm | N/A | Stable |
| Example 1 | | G1K | | | |
| Comparative | ADI | PEG400/PP | 123 nm | N/A | Stable |
| Example 2 | | G1K | | | |
| Comparative | ADI | NOP | Cannot be | N/A | Process |
| Example 3 | | (G1) | dispersed | | unstable |
| Comparative | ADI | NOP | Partly | 2100 | Product |
| Example 4 | | (G1) | Gelled | | unstable |
| Comparative | IPDI | NOP | Gelled at | N/A | Process |
| Example 5 | | (G1) | stage (7) | | unstable |
| Comparative | HDI | NOP | Gelled at | 2000 | Process |
| Example 6 | | (G1) | stage (7) | | unstable |

| | | |
|---|---|---|
| Compatative | Cold blend Bayer PR-240 (a commercial PUD) with commercial acrylic binder | Storage |
| Example 7 | | unstable |

### iii) Transparency of the Clear Films

The PUA hybrid dispersions give much better transparency than the PUA cold blend dispersion (Comp. 7). Among all the PUA hybrid dispersions, the one prepared from ADI/NOP(G4) (Exp. 2) showed the best transparency. Although those prepared from TDI/(PEG400+PPG1K) and ADI/(PEG400+PPG1K) also showed good transparency, they showed yellowish problem, especially for TDI/(PEG400+PPG1K) system (Comp. 1).

### iv) Accelerated Durability of Clear Films

### (a) Equipment

Fluorescent UV Accelerated Weathering Tester (QUV/Spray, Q-Lab, Cleveland, Ohio, USA) was used for the test: light source UVA (340), black-panel temperature (60±3), irradiance 0.68 w/m². Using the cycle of 4 hrs QUV followed by 4 hrs condensation.

### (b) Sample Preparation

Draw-down the dispersion on cement panel having a base coat of 40PVC white paint (100% acrylic binder such as Primal™ AC-261P), wet film thickness 250 um). Cure 7 days in consistant temperature room (CTR) (25° C.*60%).

### (c) Testing

Put specimen into the tester, test color change (AE), gloss change every 100 hrs with colorimeter.

Weather durability of clear films was tested based on Lab color space method. This method is a color-opponent space with dimension L for lightness and a/b for the color-opponent dimensions, based on nonlinearly compressed CIE XYZ color space coordinates.

### (d) Results

The dispersion with the presence of TDI showed serious yellowing issue (Comp. 1, highest b value represents highest yellowing), as well as lower initial gloss. But ADI/NOP (G4) system (Exp. 2) showed good gloss and clearance for the clear film (Table 2).

TABLE 2
Weather durability of clear films
Substrate: 40PVC white paint

| Sample | Comp. 1 | Comp. 2 | Exp. 2 |
|---|---|---|---|
| Lightness (L) | 95.67 | 96.16 | 96.62 |
| Color-opponent dimension, a | −1.71 | −1.49 | −1.2 |
| Color-opponent dimension, b | 6.01 | 3.72 | 1.08 |
| 20° Gloss | 40.8 | 52.00 | 74.2 |
| 60° Gloss | 80.4 | 86.1 | 85.6 |
| 85° Gloss | 91.3 | 81.9 | 95.7 |

After 250 hrs of QUV accelerated tests, ADI/NOP (G4) system (Exp. 2) showed good color and gloss retention, no yellowing or other issue was noticed, while TDI/(PEG400+PPG1K) sample (Comp. 1) showed serious yellowing issue and gloss decrease (Table 3).

TABLE 3
QUV test results (after 250 hrs)

| UV Resistance | Comp. 1 | Comp. 2 | Exp. 2 |
|---|---|---|---|
| Δ b, yellowness index | 21.3 | 0.08 | −0.13 |
| Δ gloss, 60° | −22.4 | — | −1 |

### v) Water Whitening Resistance

From Table 4, it was found that ADI/NOP (G4) system (Exp. 2) showed the best water whitening resistance (WWR) performance after 7 days immersion in de-ionized water, no visible whitening was noticed. ADI/(PEG400+PPG1K) sample (Comp. 2) shows worse WWR performance than the Exp. 2.

TABLE 4
Water whitening resistance test results (after 7 days)
Water whitening resistance

| | Comp. 1 | Comp. 2 | Exp. 2 |
|---|---|---|---|
| Initial whiteness (L₀) | 22.76 | 23.43 | 24.33 |
| Whiteness after one day (L₁) | 23.25 | 34.78 | 24 |
| Whiteness after 7 days (L₇) | 24.34 | 36.61 | 23.57 |
| ΔL(after 7 days) | 1.58 | 13.18 | −0.76 |

In summary, compared with general PUD or PUA formulations, the inventive raw materials (ADI and NOP) provide an improved exterior wall coating application, they bring excellent performance advantages such as weather durability, anti-yellowing resistance, water whitening resistance, etc.

1. A process for preparing polyurethane/acrylic hybrid dispersions comprising the following continuous steps:
a) reacting natural oil polyol with 1,3-bis(isocyanatomethyl)cyclohexane, or 1,4-bis(isocyanatomethyl)cyclohexane, hexamethylene diisocyanate, or mixture thereof, to form a polyurethane prepolymer with the weight average molecular weight being from 2800 to 5600;
b) adding as a diluent simultaneously with/after step a), but before step c), 10-50% methyl methacrylate by weight based on the total weight of polyurethane prepolymer;
c) adding hydroxyl carboxylic acids as water-dispersibility enhancing agents to the polyurethane prepolymer;
d) dispersing and extending the polyurethane prepolymer in the presence of methyl methacrylate; and
e) adding at least one ethylenically unsaturated nonionic monomer(s) and co-polymerizing it together with the diluent methyl methacrylate.

2. A process for preparing polyurethane/acrylic hybrid dispersions comprising the following continuous steps:
a) reacting natural oil polyol with isophorone diisocyanate, to form a polyurethane prepolymer with the weight average molecular weight being between 1600-2200;
b) adding as a diluent simultaneously with/after step a), but before step c), 10-50% methyl methacrylate by weight based on the total weight of polyurethane prepolymer;
c) adding hydroxyl carboxylic acids as water-dispersibility enhancing agents to the polyurethane prepolymer;
d) dispersing and extending the polyurethane prepolymer in the presence of methyl methacrylate; and
e) adding at least one ethylenically unsaturated nonionic monomer(s) and co-polymerizing it together with the diluent methyl methacrylate.

3. The process for preparing polyurethane/acrylic hybrid dispersions according to claim 1, further comprising adding hydroxyl ethyl methacrylate, as an acrylic end-capping agent after the polyurethane prepolymer is prepared.

4. The process for preparing polyurethane/acrylic hybrid dispersions according to claim 1, wherein the natural oil polyol is derived from soybean oil.

5. The polyurethane/acrylic hybrid dispersions prepared according to the process of claim 1.

6. A coating composition containing the polyurethane/acrylic hybrid dispersions according to claim 5.

7. The process for preparing polyurethane/acrylic hybrid dispersions according to claim 2, further comprising adding hydroxyl ethyl methacrylate, as an acrylic end-capping agent after the polyurethane prepolymer is prepared.

8. The process for preparing polyurethane/acrylic hybrid dispersions according to claim 2 wherein the natural oil polyol is derived from soybean oil.

9. The polyurethane/acrylic hybrid dispersions prepared according to the process of claim 2.

10. A coating composition containing the polyurethane/acrylic hybrid dispersions according to claim 9.
